(19) United States
(12) Patent Application Publication
(10) Pub. No.: US 2003/0107591 A1
(43) Pub. Date: Jun. 12, 2003

(54) Collection role changing GUI

(76) Inventor: Kevin W. Jameson, Calgary (CA)

Correspondence Address: KEVIN JAMESON, 148 EDGEBANK PLACE NW, CALGARY, AB, T3A 4L4, CA

(21) Appl. No.: 10/003,423

(22) Filed: Dec. 6, 2001

(51) Int. Cl. G09G 5/00

(52) U.S. Cl. 345/744

(57) ABSTRACT

A Collection Role Changing GUI has the ability to dynamically change GUI “roles”—the sets of menus and toolbars provided to human users—thereby making it possible to optimize the match between provided GUI functionality and current user functionality requirements.

In operation, a Collection Role Changing GUI receives a role change request, obtains associated role definition data from a role data storage means, and modifies visible GUI display elements to reflect the new role menus and toolbars.

Collection Role Changing GUIs provide users with extensible, customizable, and sharable GUI interfaces that can be precisely configured to meet specific user functionality requirements, thereby increasing user productivity in ways that were not previously possible.

### CROSS REFERENCES TO RELATED APPLICATIONS

The present invention uses inventions from the following patent applications, which are incorporated herein by reference:

Collection Knowledge System, U.S. patent application Ser. No. 09/885,079, filed Jun. 21, 2001 Kevin W Jameson.

Collection Extensible Action GUI, USPTO Application filed contemporaneously herewith, Kevin W Jameson.

### FIELD OF THE INVENTION

This invention relates to graphical user interfaces for processing collections of computer files in arbitrary ways, thereby improving the productivity of software developers, web media developers, and other humans that work with collections of computer files.

### BACKGROUND OF THE INVENTION

The Overall Problem

The general problem addressed by this invention is the low productivity of human knowledge workers who use labor-intensive manual processes to work with collections of computer files. One promising solution strategy for this software productivity problem is to build automated systems to replace manual human effort.

Unfortunately, replacing arbitrary manual processes performed on arbitrary computer files with automated systems is a difficult thing to do. Many challenging sub-problems must be solved before competent automated systems can be constructed. As a consequence, the general software productivity problem has not been solved yet, despite large industry investments of time and money over several decades.

The present invention provides one piece of the overall functionality required to improve the productivity of human knowledge workers—a better user interface.

In particular, the present Collection Role Changing GUI invention has a practical application in the technological arts because it provides a GUI interface that can dynamically change its operational functionality to suit the functional needs of various human work roles, thereby improving human work efficiency and productivity.

Introduction to GUI Interfaces

The main goal of all user interfaces is to facilitate human productivity by making it convenient and efficient for humans to accomplish work. To this end, various kinds of user interfaces have been created over the years to improve user productivity. Two important types of interfaces are command line interfaces (also known as CLI or shell window interfaces) and graphical user interfaces (GUIs).

Technically speaking, user interfaces provide human users with means for initiating work events that in turn perform work operations. Work events are commonly initiated by typing a command line into a shell window, or by clicking on menu choices or toolbar buttons on a GUI interface. Work operations are typically implemented as independent command line scripts or programs, or as subroutine calls within GUI interface programs.

Dominant CLI Design Strategies

Simply put, there are no dominant CLI design strategies. All CLI interfaces are essentially the same—users type command lines into a CLI window, and the operating system executes the command line. Although Unix command line I/O models (pipes, tees, redirections) from the 1970s were novel, it is substantially fair to say that CLI interfaces have not really changed much in the past several decades.

Dominant GUI Design Strategies

In contrast to CLI interfaces, GUI interfaces have evolved significantly during the past 30 years.

For several decades now, the dominant GUI interface design strategy has been to write a unique GUI interface for each distinct user application domain. For example, unique GUI interfaces have been implemented for spreadsheet programs, word processing programs, email programs, and database programs.

The “one GUI per application domain” design strategy makes sense because each unique GUI interface provides users with a custom set of GUI work operations that are related to the data and operations used within a particular application domain. As a counter example, to illustrate the point again, it makes little sense to provide spreadsheet buttons on a word processing interface, or to provide word processing buttons on a database interface.

The “one GUI per application domain” design strategy also makes sense from a marketing point of view, because a unique GUI interface can be more easily differentiated from other products in the marketplace.

A second part of the dominant GUI design strategy provides a fixed set of work operations for each unique GUI interface. To build an interface, GUI designers study user requirements in an application domain, identify a set of work operations that should be provided by a GUI interface for that domain, then implement those work operations. Thus GUI work operations are tuned to the needs of an application domain.

The “fixed set of work operations” design strategy makes sense because it provides sufficient GUI functionality to meet application domain requirements. Indeed, most mature GUI products in the current marketplace (such as spreadsheets and word processors) provide a large excess of functionality beyond the needs of most users.

To summarize, the two dominant GUI design strategies of “one GUI per application domain” and “a fixed set of work operations” are successful because they substantially satisfy the needs of human users working within an application domain.

Comparison of CLI and GUI Interfaces

Most CLI interfaces have the usual characteristics. That is, they have broad applicability because they can provide access to work operations (programs) in many application domains. Further, they have a consistent interface across all such application domains—there is no visual presentation of available work operations, or means for selecting work operations. Instead, all command lines must be known by human users in advance, and must be manually typed into the CLI interface in the usual way.

In contrast, GUI interfaces have very different characteristics. They have narrow applicability because each GUI provides work operations that are focused on only one application domain. Further, they have different interfaces across application domains—each GUI for each application domain visually presents a different set of work operations that are relevant to that particular application domain. Finally, GUIs present a fixed visual list of available work operations, and work operations must be chosen from the fixed list.

Clearly the two most important interfaces in the current marketplace have very different characteristics. GUIs are new; CLIs are old. GUIs are narrow, focused on one application; CLIs are broad, focused on no application. GUIs have fixed sets of work operations; CLIs have unbounded sets of work operations. GUIs present work operation choices visually; CLIs require advance mental understanding of possible command lines.

These striking differences between GUI and CLI interfaces implicitly pose the question of whether there is a middle ground that could provide the main advantages of both GUI and CLI interfaces in a new kind of interface.

Role Changing GUIs

The present invention contemplates a GUI interface that does not follow the “one GUI per application domain” dominant design strategy that was presented above. Instead, the present Collection Role Changing GUI invention contemplates a single GUI interface that can serve multiple user application domains (“roles”).

One key factor in the practicality of this novel design approach is the type of command flow used in the application domains that are served by the present invention.

Types of Command Flow In User Interfaces

Two types of command flow in user interfaces are of interest: linear flow and eddy flow.

Linear command flow occurs when execution proceeds linearly from invocation, through execution, to termination—without further human input during the execution phase. Linear command flow can be seen in most command line programs, scripts, and batch files—once started, they run to completion without further human input. Linear command flow is particularly good for automated processes because no human input is required after invocation.

Eddy command flow occurs when program execution proceeds from invocation, into an iterative command input loop, and to termination only when an exit command is given to the command loop. Eddy flow can be seen in GUI application programs that have internal command loops for receiving user input during the GUI program execution phase. For example, spreadsheets and word processors are good examples of GUI applications that use eddy command flow. Eddy command flow applications are good for interactivity, since they can receive interactive commands from humans, and can display the results of each interactive command immediately. Eddy command flow applications exit only when an exit command is given to the command loop.

Linear and eddy command flows are not generally interchangeable within application domains. To a first approximation, some application domains (such spreadsheets and word processors) require interactive GUI user interfaces with eddy flow for reasonable productivity, and some application domains (such as single-action programs and automated scripts) require command line programs with linear command flow for reasonable productivity.

The relationship between application domain and command flow model is important because it means that mismatches between application domains and user interfaces tend to reduce productivity to discouraging levels.

The present invention contemplates a Collection Role Changing GUI for use in multiple, linear command flow application domains. A Collection Role Changing GUI can dynamically change its set of visible work operations to suit changes in user work focus—thereby optimizing the match between provided GUI functionality and current user functionality requirements.

In order to construct a Collection Role Changing GUI, several important technical problems must be solved.

Problems to Solve

The Collection Role Changing GUI Problem is an important, fundamental problem that must be solved to enable the construction of Role Changing GUI interfaces. It is the problem of how to provide users with a single GUI interface that can support multiple human work roles in linear command flow application domains.

Some interesting aspects of the Collection Role Changing GUI problem are these: arbitrary numbers of user-defined roles are possible; each role can specify arbitrary changes to menus, toolbars, and the implementation of underlying work operations; and roles may have platform dependent behavior.

The Role Focus Gain Problem is another important problem that must be solved to enable the construction of Role Changing GUI interfaces. It is the problem of how to represent and perform various operations when GUI focus is lost from an old role and gained by a new role.

Some interesting aspects of the Role Focus Gain Problem are these: arbitrary focus loss actions may be requested; arbitrary focus gain actions may be requested; multiple numbers of focus loss or gain actions may be required.

The Role Focus Variable Problem is another important problem that must be solved to enable the construction of Role Changing GUI interfaces. It is the problem of how to represent and instantiate new focus variables and focus variable values when GUI focus changes from one role to another.

Some interesting aspects of the Role Focus Variable Problem are these: arbitrary numbers of focus variables may be involved; focus variables contain string values; focus variables can be related to each other in focus variable groups; focus variables can be used in focus-loss and focus-gain actions.

The Customized Role Problem is another important problem that must be solved to enable the construction of Role Changing GUI interfaces. It is the problem of how to represent and manage all site, project, team, and individual customizations for data used by a Role Changing GUI.

Some interesting aspects of the Customized Role Problem are these: arbitrary numbers of menus, toolbars, and work operations within a role may be customized; arbitrary numbers of site, team, project, and individual customizations may be involved; customizations can be platform dependent; customizations can be shared among GUI users; and centralized administration of shared customizations is desirable.

The Sharable Role Problem is another important problem that must be solved to enable the construction of Role Changing GUI interfaces. It is the problem of sharing user-defined role data among all users and machines in a networked computing environment.

Interesting aspects of the Sharable Role Problem are these: arbitrary numbers of users may be involved; sharable roles can be organized into groups of related shared roles; users may be organized into groups of related users that share the same role data; individual customizations to shared group role data may also be shared; centralized administration of sharing rules is desirable.

The Scalable Role Storage Problem is another important problem that must be solved to enable the construction of Role Changing GUI interfaces. It is the problem of how to manage large numbers of multi-platform roles in a networked computing environment.

Some interesting aspects of the Scalable Role Storage Problem are these: arbitrary numbers of roles may be involved; role definitions can be accessed by any computer on the network; roles, or groups of related roles, can be shared among many different users and platforms; centralized administration of stored role definitions is desirable.

As the foregoing discussion suggests, creating Role Changing GUI interfaces that can share role data in a scalable way is a complex problem involving several degrees of freedom. No competent general solution to the overall problem is visible in the prior art today, even though the first GUI interfaces were created over 30 years ago.

General Shortcomings of the Prior Art

The following discussion is general in nature, and highlights the significant conceptual differences between the file-oriented, single-application GUI interfaces of the prior art, and the novel multiple-application Role Changing GUI represented by the present invention.

Prior art approaches lack support for role-oriented behavior. This is the largest limitation of all because it prevents prior art approaches from adapting to changing work roles and thereby improving human productivity.

Prior art approaches lack support for understanding user work roles. As a consequence, they cannot adapt their provided functionality to better support user work roles, thereby improving human productivity.

Prior art approaches lack support for customizing many different GUI role definitions, thereby making it impossible to simultaneously serve the custom needs of many human users that each participate in many different work roles, and that each have their own customization preferences.

Prior art approaches lack support for sharing large numbers of user-defined role definitions (and their respective customizations) among a large population of human users and user groups, thereby making it impossible to reuse role definitions effectively.

Prior art approaches lack support for managing large numbers of user-defined role definitions in a scalable way, thereby making it very difficult to provide a uniform set of role definitions to a large population of human users in a networked computing environment.

As can be seen from the above description, prior art user interface approaches have several important limitations. Notably, they are not role-oriented, and are not generally extensible, customizable, or scalable.

In contrast, the present Collection Role Changing GUI has none of these limitations, as the following disclosure will show.

### SUMMARY OF THE INVENTION

A Collection Role Changing GUI has the ability to dynamically change GUI “roles”—the sets of menus and toolbars provided to human users—thereby making it possible to optimize the match between provided GUI functionality and current user functionality requirements.

In operation, a Collection Role Changing GUI receives a role change request, obtains associated role definition data from a role data storage means, and modifies visible GUI display elements to reflect the new role menus and toolbars.

Collection Role Changing GUIs provide users with extensible, customizable, and sharable GUI interfaces that can be precisely configured to meet specific user functionality requirements, thereby increasing user productivity in ways that were not previously possible.

Objects and Advantages

The main object of a Collection Role Changing GUI is to provide a GUI interface that has role-oriented behavior. That is, a GUI that can dynamically change GUI “roles”—the sets of menus and toolbars provided to human users—thereby making it possible to optimize the match between provided GUI functionality and current user functionality requirements.

Another object is to provide support for user-defined work roles, thereby enabling users to create new GUI role definitions to support particular user work roles that require particular GUI menus and toolbars.

Another object is to provide support for customizing large numbers of role definitions, thereby enabling users to customize roles in accordance with site, project, team, and individual customization preferences.

Another object is to provide support for sharing large numbers of user-defined and user-customized role definitions among a large population of users and user groups, thereby enabling a community of users to share the same role definitions, and thereby gaining the cost and maintenance advantages of software role reuse.

Another object is to provide support—scalable support—for managing large numbers of role definitions, thereby enabling role administrators to provide users with role definitions that are drawn from a centrally administered pool of role definitions.

As can be seen from the objects above, Collection Role Changing GUIs can provide many benefits to human knowledge workers. Collection Role Changing GUIs can help to improve human productivity by dynamically changing GUI menus and toolbars to fit user computational requirements, in ways that were not previously possible.

Further advantages of the present Collection Role Changing GUI invention will become apparent from the drawings and disclosures that follow.

### BRIEF DESCRIPTION OF DRAWINGS

FIG. 1 shows a simplified architecture for a Collection Role Changing GUI 130.

FIG. 2 shows a simplified data structure for a role change request.

FIG. 3 shows a simplified algorithm for a Collection Role Changing GUI 130.

FIG. 4 shows a simplified architecture for a Module Role Change Manager 131.

FIG. 5 shows a simplified algorithm for for a Module Role Change Manager 131.

FIG. 6 shows a simplified architecture for a Module Get Role Data 150.

FIG. 7 shows a simplified algorithm for a Module Get Role Data 150.

FIG. 8 shows a simplified architecture for a Module Perform Role Change 200.

FIG. 9 shows a simplified algorithm for a Module Perform Role Change 200.

FIG. 10 shows an initial GUI configuration file that specifies an initial GUI role that should be used at GUI invocation time.

FIG. 11 shows an example role name table and two example role definition files.

FIG. 12 shows an example layout name table and two example layout definition files.

FIG. 13 shows an example menubar name table and two example menubar definition files.

FIG. 14 shows an example menu name table and two example menu definition files.

FIG. 15 shows an example toolbar name table and one example toolbar definition file.

FIG. 16 shows an example button name table and one button definition file.

FIG. 17 shows an example icon name table containing several icon names and icon bitmap filenames.

FIG. 18 shows an example action name table that associates many action names with corresponding action definition files.

### LIST OF DRAWING REFERENCE NUMBERS

121 Role Data Storage Means

130 Collection Role Changing GUI

131 Module Role Change Manager

132 Module Role Focus Loss Manager

150 Module Get Role Data

151 Module Load Role Definition

152 Module Load Layout Definition

153 Module Load Menubar Definition

154 Module Load Menu Definitions

155 Module Load Toolbar Definitions

156 Module Load Button Definitions

200 Module Perform Role Change

201 Module Update Internal Data Structures

202 Module Role Focus Gain Manager

250 Module Redisplay GUI Role

### DETAILED DESCRIPTION

GUI Architecture Terminology

This section defines various terms used in this document.

A GUI Role is a set of related GUI menus, toolbars, and underlying executable actions that is designed to support a particular type of human work. The main idea behind a GUI role is to provide human workers an optimal set of menu choices and toolbar buttons for accomplishing the particular type of work that is currently being done. For example, a human working in a programmer role would be provided with menus and buttons useful for programming. A human working in a documenter role would be provided with menus and buttons useful for working with documents. A human working as a team manager would be provided with menus and buttons useful for working with teams, projects, timesheets, task lists. And so on. In a technical sense, GUI roles are comprised of a GUI layout and optional focus variables and associated values.

A GUI Layout specifies a list of menubars and toolbars that are visibly displayed on a computer display screen. Layouts determine the set of menu choices and toolbar buttons that are visibly provided to human workers.

A GUI Menubar specifies a list of menus that are visibly displayed across the top of a GUI display window. Most menubars contain the popular File, Edit, View, and Help menus.

A GUI Menu specifies a list of menu choices that are visibly displayed below a menu name on a menubar. Menu choices represent a major part of the operative functionality that is available through a GUI interface (toolbar buttons provide the rest of the functionality). For example, most File menus contain the popular File New, File Open, File Save, and File Save As menu choices.

A GUI Menu Choice is an individual choice on a GUI menu. A menu choice invokes a GUI action to perform useful computational work. For example, a File Save menu choice could invoke a GUI action to save a current document onto a computer disk.

A GUI Toolbar specifies a list of buttons (or other GUI controls) that are visibly displayed below a menubar on a GUI window. Multiple toolbars may be displayed on many modern GUI interfaces. For example, many toolbars contain the popular New, Open, Save, Cut, Copy, and Paste buttons.

A GUI Toolbar Button is an individual button on a toolbar. A toolbar button invokes a GUI action to perform useful computational work. For example, a File Save button could invoke a GUI action to save a current document onto a computer disk.

A GUI Action is a technical means that implements the function of an individual menu choice or toolbar button. GUI actions are typically implemented by executing internal GUI program code, by making external operating system calls, or by a combination of both. GUI actions typically use dialogs, dynamic lists, and focus variables to accomplish their computational functions.

A GUI Focus Variable is an internal GUI variable that can hold text strings of interest to the GUI role or to the human user. Focus variables are user-definable, so users can define their own variables and associated values. The main purpose of focus variables is to provide runtime substitution values for placeholder (parameter) variable names in executable action templates.

A GUI Focus Variable Group is a group of internal GUI focus variables. The main purpose of a focus variable group is to keep related focus variables together so their values can be managed as a set. Focus variable groups are user-definable, so users can define their own groups of focus variables and associated values.

A GUI Dialog is a pop-up GUI window that interacts with human GUI users. One example of a typical GUI dialog is a selection dialog, which provides a list of values to a human user that selects one or more values of interest.

A GUI List is a list of static values that is used in action dialogs or action command lines. The main purpose of static lists is to provide lists of items that comprise a set. For example, a list might contain a static list of site projects, repositories, or personnel categories. Static lists are useful for listing things that do not change frequently.

A GUI Dynamic List is a list of current values that is obtained at runtime, and then is used in action dialogs or action command lines. The main purpose of dynamic lists is to provide actions with a way of obtaining current lists of values for use in selection dialogs. For example, a dynamic list might be used to query a remote server for a list of current items stored on the server, so that local GUI users could select interesting values from the dynamic list. Dynamic lists are most useful for listing sets of things whose membership changes frequently.

Extensible GUI Layout Data

This section is an introduction to the structure and organization of Extensible GUI Layout Data files, which model GUI functionality from the layout level (high-level) to to the action level (mid-level).

The intent of this material is to provide readers with an overview of how GUI layouts can be modeled by simple, user-defined layout data files.

For an introduction to the structure and organization of Extensible GUI Action Data files, which model GUI functionality from the action level (mid-level) to the executable level (low-level), see the related patent application “Collection Extensible Action GUI” listed in the related patent applications section at the beginning of this document.

Although the examples shown here use simple ASCII files for presentation clarity, readers of ordinary skill in the art will immediately appreciate that the ASCII files shown here could easily be implemented using more advanced data storage means such as relational databases.

GUI Default Configuration

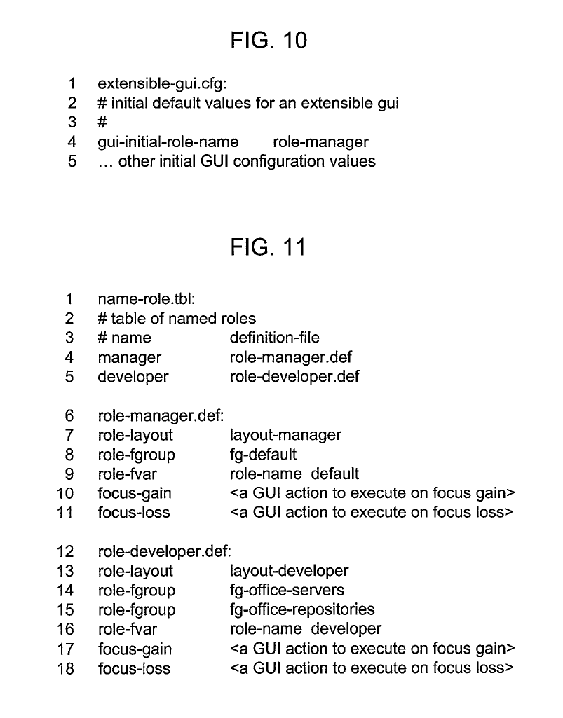

FIG. 10 shows an example initial configuration file for an extensible GUI. The configuration file contains various default values that are loaded by a GUI when it is first activated.

In particular, FIG. 11 Line 4 shows the name of a GUI layout “layout-manager” that should be loaded when the GUI is first invoked.

GUI Layouts

A GUI Layout specifies a list of menubars and toolbars that are visibly displayed on a computer display screen. Thus layouts determine the set of menu choices and toolbar buttons that are visibly provided to human workers.

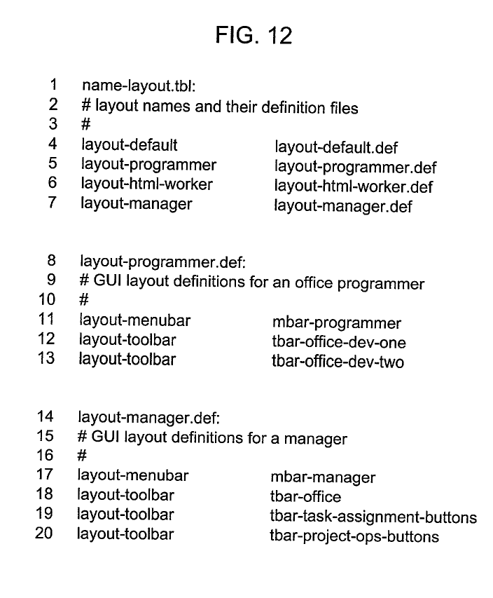

FIG. 12 shows an example layout name table Lines 1-7 and two example layout definition files Lines 8-13 and Lines 14-20 respectively.

To activate a particular named layout, a GUI searches for the layout name in Column 1 of the layout name table, to obtain a corresponding definition filename from Column 2.

For example, to activate a layout named “layout-manager”, a GUI matches the layout name in layout name table FIG. 11 Line 7 Column 1, and obtains a layout definition filename “layout-manager.def” from Column 2. Next, a GUI uses the layout definition filename to locate a corresponding layout definition file FIG. 12 Lines 14-20. The layout definition file specifies a menubar Line 17 and one or more toolbars Lines 18-20 to display as part of the layout.

GUI Menubars

A GUI Menubar specifies a list of menus that are visibly displayed across the top of the GUI display window. Most menubars contain the popular File, Edit, View, and Help menus.

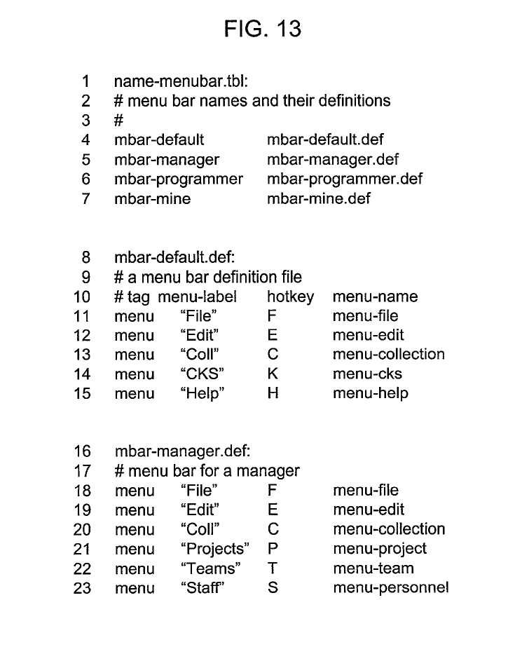

FIG. 13 shows an example menubar name table Lines 1-7. Column 1 of the table contains menubar names. Column 2 contains the name of corresponding menubar definition files.

FIG. 13 shows two example menubar definition files Lines 8-15, Lines 16-23. Each definition file contains a list of menus that should appear on the menubar. The first menu in the list is the leftmost menu on the displayed bar; the last menu in the list is the rightmost menu on the menubar.

FIG. 13 Line 11 Column 1 contains a menu tag. Column 2 contains the menu label that appears on the final GUI display. Column 3 contains the menu “hotkey” letter. Column 4 contains the name of a corresponding menu definition file.

To activate a particular menubar, a GUI looks up the desired menubar name (e.g. “mbar-manager”) in the menubar name table FIG. 13 Line 5 to obtain a menubar definition filename “mbar-manager.def.” Then menu information is read from the corresponding definition file FIG. 13 Lines 8-15.

GUI Menus

A GUI Menu specifies a list of menu choices that are visibly displayed below a menu name on a menubar. Menu choices represent a major part of the operative functionality that is available through a GUI interface (toolbar buttons provide the rest of the functionality). For example, most File menus contain the popular File New, File Open, File Save, and File Save As menu choices.

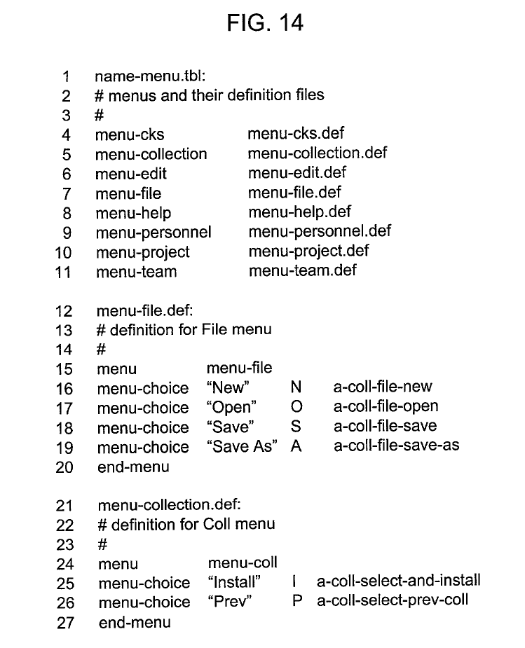

FIG. 14 shows an example menu name table Lines 1-11. Column 1 contains menu names. Column 2 contains definition filenames.

FIG. 14 Lines 12-20 shows an example menu definition file for the “menu-file” menu. FIG. 14 Lines 21-27 shows an example menu definition file for the “menu-collection” menu. Menu definition files define menu choices that will appear on the menu.

A GUI Menu Choice is an individual choice on a GUI menu. The function of a menu choice is to invoke a GUI action to perform useful computational work. For example, a File Save menu choice could invoke a GUI action to save the current document onto a computer disk.

FIG. 14 Lines 16-19 Column 1 contains tags that identify lines in the menu choice definition file. Column 2 contains menu choice label strings that appear on the menu choices in the final displayed GUI menus. Column 3 contains menu choice “hotkey” letters. Column 4 contains menu action names for actions that implement the computational work associated with menu choices.

To activate a particular menu, a GUI looks up a desired menu name such as “menu-file” in the menu name table FIG. 14 Line 7 to obtain a menu definition filename “menu-file.def”. Then menu choice information is read from the corresponding definition file FIG. 14 Lines 12-20.

GUI Toolbars

A GUI Toolbar specifies a list of buttons (or other GUI controls) that are visibly displayed below a menubar on a GUI window. Multiple toolbars may be displayed on many modern GUI interfaces.

For example, many toolbars contain the popular New, Open, Save, Cut, Copy, and Paste buttons.

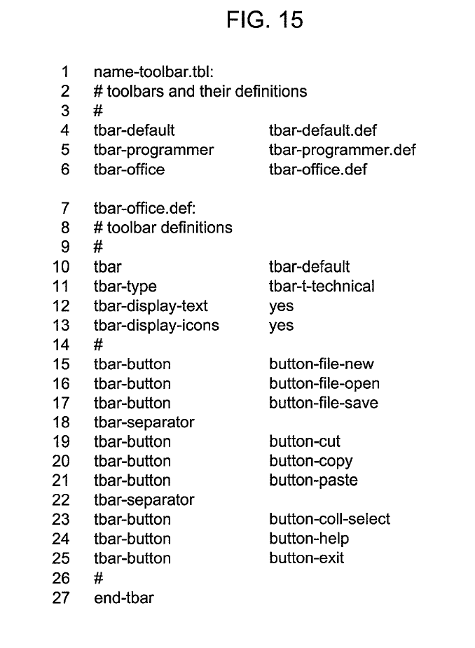

FIG. 15 Lines 1-6 show an example toolbar name table. Column 1 contains toolbar names. Column 2 contains corresponding toolbar definition filenames. FIG. 15 Lines 7-27 show an example toolbar definition file for the “tbar-office” toolbar. Column 1 contains tags that identify various lines and toolbar attributes in the definition file. Column 2 contains attribute values.

To activate a particular toolbar, a GUI looks up a desired toolbar name such as “tbar-office” in the toolbar name table FIG. 15 Line 6 to obtain the name of a corresponding toolbar definition file “tbar-office.def.” Then toolbar definition information is read from the corresponding definition file FIG. 15 Lines 7-27.

GUI Toolbar Buttons

A GUI Toolbar Button is an individual button on a toolbar. The function of a button is to invoke a GUI action to perform useful computational work. For example, a File Save button could invoke a GUI action to save the current document on to a computer disk.

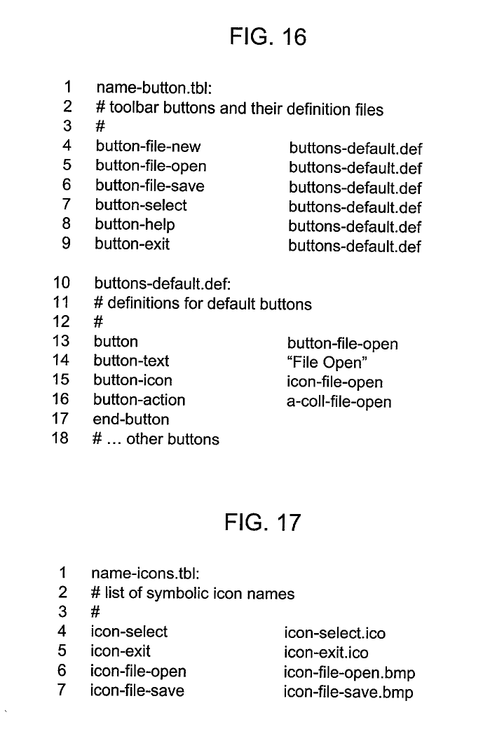

FIG. 16 Lines 1-9 show an example button name table. Column 1 contains button names. Column 2 contains button definition filenames. Multiple buttons can be defined in one file.

FIG. 16 Lines 10-18 show an example button definition file. Column 1 contains line tags that identify various attributes within a button definition. Column 2 contains attribute values.

FIG. 17 shows an example icon definition file. Column 1 contains line tags that identify various icon attributes within an icon definition file. Column 2 contains attribute values.

To activate a particular toolbar button, a GUI looks up a desired button name such as “button-file-open” in a button name table FIG. 16 Line 5 to obtain the name of a corresponding button definition file “buttons-default.def.” Button definition information, including icon definition information, is read from a corresponding button definition file FIG. 16 Lines 10-18 and icon definition file FIG. 17 Line 6, for use in activating the button of interest.

GUI Actions

A GUI Action is a technical means that implements the function of individual menu choices or toolbar buttons. GUI actions are associated with menu choices FIG. 14 Line 18 (“a-cmd-file-save”) or toolbar buttons FIG. 16 Line 16 (“a-file-open”) using definition files.

GUI actions are implemented by internal GUI program code, by external operating system calls, or by a combination of both. GUI actions may use dialogs, dynamic lists, focus variables, subroutines, and external programs to accomplish their computational functions.

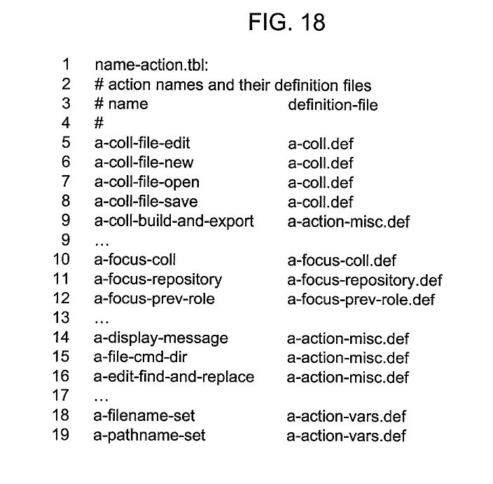

FIG. 18 shows an example action name table. Column 1 contains action names. Column 2 contains corresponding action definition filenames.

To execute a particular action, a GUI looks up a desired action name such as “a-coll-file-save” in an action name table FIG. 18 Line 8 to obtain the name of a corresponding action definition file “a-coll.def.”Action definition information is then read from an action definition file, for use in executing the work specified by the action of interest.

For more information on GUI actions, see the “Collection Extensible Action GUI” reference listed in the related patent applications section of this document.

This concludes the introduction to Extensible GUI Layout Data files.

Collection Role Changing GUI

A Collection Role Changing GUI has four major components.

One component is a GUI framework which provides means for creating a GUI user interface.

Software subroutines for constructing GUI interfaces are usually provided by the operating system.

A second component is a software means for receiving, interpreting, and responding to incoming role change requests. This component contains algorithms that distinguish a Collection Role Changing GUI from other GUI programs.

A third component is role data used by a Collection Role Changing GUI. Role data is customizable, extensible, scalable, and typically contains a significant portion of custom user-customized information.

A fourth component is a storage mechanism used to store and manage role data. The present invention contemplates a typical database or a Collection Knowledge System for managing role data. For more information on Collection Knowledge Systems, see the related patent applications listed at the beginning of this document.

The following discussion explains the overall architecture and operation of a Collection Role Changing GUI.

Collection Role Changing GUI Architecture

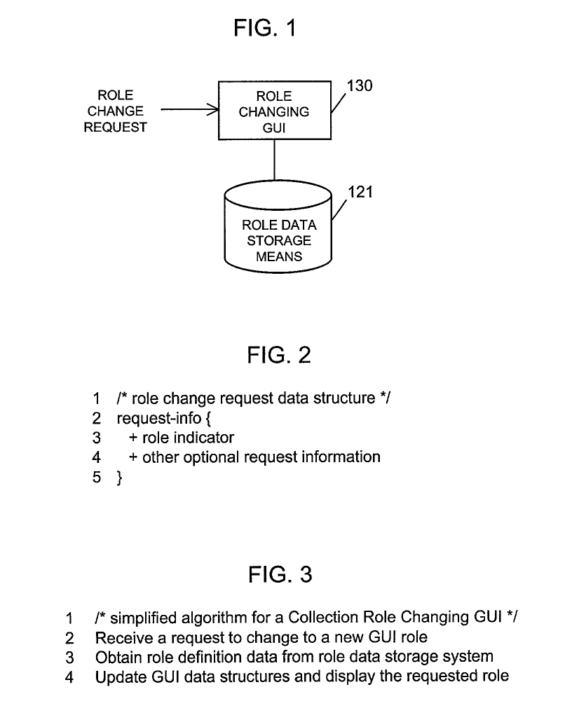

FIG. 1 shows a simplified architecture for a Collection Role Changing GUI 130.

Module Role Changing GUI 130 receives incoming role change requests FIG. 2, and in response, updates the menus and toolbars displayed on the GUI interface.

Module Role Data Storage Means 121 stores role definitions that specify which menus and toolbars are to be displayed for each role.

In operation, Module Collection Role Changing GUI 130 proceeds according to the simplified algorithm shown in FIG. 3.

First, Module Collection Role Changing GUI 130 receives and interprets a role change request. Then in response it changes the GUI interface in accordance with the role definitions stored in a Role Data Storage Means 121.

Module Role Change Manager

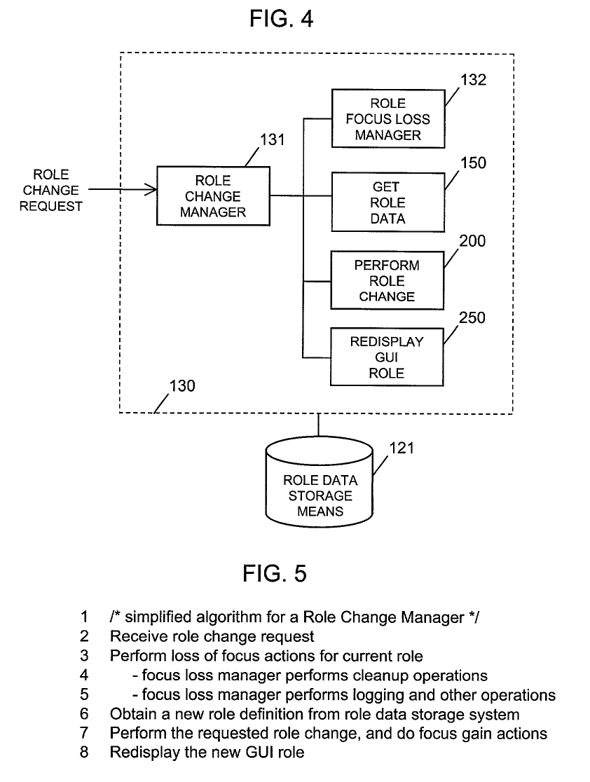

FIG. 4 shows a simplified architecture for a Module Role Change Manager 131.

Module Role Change Manager 131 oversees the interpretation of role change requests and role change responses that are specified by stored role data.

Module Role Focus Loss Manager 132 performs focus loss actions in response to the loss of focus on the current role that is caused by an incoming role change request. Focus loss actions are not special; they are normal GUI actions that are listed in an action name table FIG. 18, and that are executed in the usual manner for all GUI actions. For more information on how GUI actions are represented and executed, see the related patent application “Collection Extensible Action GUI” listed at the beginning of this document.

Module Get Role Data 150 interprets incoming role change requests, and in response, produces new full role definitions in accordance with stored role data.

Module Perform Role Change 200 implements the required the new role by calculating new GUI operational and display parameters such as new menus and toolbars and actions.

Module Redisplay GUI Role 250 completes the role change response by displaying the new GUI role on a computer display screen.

Operation

FIG. 5 shows a simplified algorithm for for a Module Role Change Manager 131.

First, Role Change Manager 131 passes an incoming role change request FIG. 2 to Module Role Focus Loss Manager 132, which performs cleanup or logging actions required by the GUI as the GUI focus is lost from the current role.

Next, Role Change Manager 131 passes the incoming role change request to Module Get Role Data 150 for interpretation. In response, Module Get Role Data 150 obtains a corresponding role definition from a Role Data Storage Means 121.

Next, Role Change Manager 131 passes the obtained role definition to Module Perform Role Change 200. This module replaces the existing GUI role with a new role, thereby implementing the requested role change.

Module Role Change Manager 131 is responsible for instantiating new role focus variables and focus variable groups before it executes focus-gain actions for the new role. This order is required if focus-gain actions are to have access to focus variables associated with the new role.

Finally, Role Change Manager 131 calls Module Redisplay GUI Role 250 to update the physical computer screen on which the Collection Role Changing GUI 130 is displayed.

Role Focus Actions

FIG. 11 shows an example role name table Lines 1-5 and two role definition files Lines 6-11, Lines 12-18. Lines 10-11 and Lines 17-18 specify actions to be executed when focus on a GUI role is gained or lost.

The main purpose of role focus actions is to provide a means for specifying and executing useful actions at role tear down times (focus loss) and role set up times (focus gain). For example, a GUI could produce time-stamped log entries whenever a particular role gained or lost focus. From the log entries, statistics could then be calculated on role usage counts, average role durations, and so on.

Role Focus Variables

FIG. 11 Line 9 and Line 16 show examples of GUI focus variables that are instantiated as part of a role when focus on a new GUI role is gained. For example, Line 9 Column 2 contains the name of a focus variable, and Line 9 Column 3 contains the corresponding string value of the focus variable. Similarly, Line 16 specifies “developer” as the value of a focus variable named “rolename.”

GUI Focus Variables are internal GUI variable that can hold text strings of interest to a GUI role or to a human user. The main purpose of focus variables is to provide runtime substitution values for placeholder (parameter) variable names in action command templates. Focus variables are user-definable, so users can define their own variables and associated values.

FIG. 11 Line 8 and Lines 14-15 show examples of GUI focus variable groups that are instantiated as part of a role when focus on a new GUI role is gained.

GUI Focus Variable Groups are groups of internal GUI focus variables. The main purpose of focus variable groups is to keep related focus variables together so that their values can be managed simultaneously. Focus variable groups are user-definable, so users can define their own groups of focus variables and associated values.

In operation, focus variables and focus variable groups are maintained within internal GUI tables of focus variables and focus variable groups. New role focus variables and values are added to the tables as new GUI roles are installed, usually before focus-gain actions are executed. As one possible preferred implementation example, hash tables may be used to store focus variables and their values.

Module Get Role Data

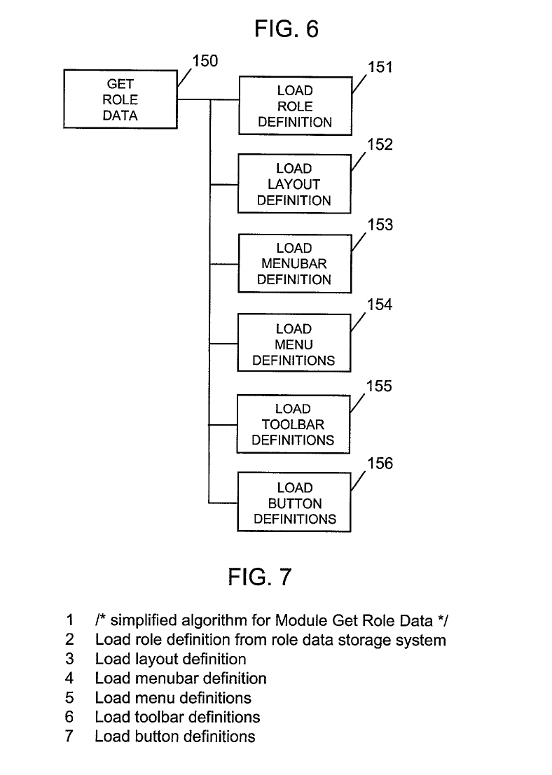

FIG. 6 shows a simplified architecture for a Module Get Role Data 150.

Module Get Role Data 150 obtains complete role data to support the requested role change.

Module Load Role Definition 151 loads role definition information FIG. 11 from a Role Data Storage Means 121.

Module Load Layout Definition 152 loads layout definition information FIG. 12 from a Role Data Storage Means 121.

Module Load Menubar Definition 153 loads menubar definition information FIG. 13 from a Role Data Storage Means 121.

Module Load Menu Definitions 154 loads menu definition information FIG. 14 from a Role Data Storage Means 121.

Module Load Toolbar Definitions 155 loads toolbar definition information FIG. 15 from a Role Data Storage Means 121.

Module Load Button Definitions 156 loads button definition information FIG. 16 from a Role Data Storage Means 121.

Operation

FIG. 7 shows a simplified algorithm for a Module Get Role Data 150. Module Get Role Data 150 calls various subordinate Modules 151-156 to perform necessary work.

First, Module Load Role Definition 151 is called to obtain role definition information from a Role Data Storage Means 121. Module Load Role Definition 151 obtains a role identifier from the incoming role change request. The role identifier specifies the new role that is the target of the role change operation. The role identifier, once obtained, is used as a lookup key into a role name table FIG. 11 Lines 1-5 to obtain the name of a role definition file from Column 2 of the name table. The name of the role definition file is used to locate a role definition file containing complete role data, such as the role definition files shown in FIG. 11 Lines 6-11 and Lines 12-18.

For example, if the incoming role name in a role change request is “role-manager”, a lookup match is obtained on FIG. 11 Line 4 Column 1. The name of the corresponding role definition file is found in Column 2, “role-manager.def.” The corresponding definition file is shown in FIG. 11 Lines 6-11.

Next, Module Load Layout Definition 152 is called to obtain GUI layout definition information from a Role Data Storage Means 121. Module Load Layout Definition 152 obtains a layout name from a role definition file FIG. 11, and looks up the layout name in a layout name table FIG. 12 Line 7 to obtain the name of a corresponding layout definition file.

For example, if a role definition file contains a layout name of “layout-manager” FIG. 11 Line 7, a lookup match is obtained in the layout name table FIG. 12 Line 7, and the corresponding layout definition file is shown in FIG. 12 Lines 14-20.

Next, Module Load Menubar Definition 153 is called to obtain menubar definition information from a Role Data Storage Means 121. Module Load Menubar Definition 153 obtains a menubar name from a layout definition file FIG. 12, and looks up the menubar name in a menubar name table FIG. 13 Lines 1-7 to obtain the name of a corresponding menubar definition file.

For example, if a layout definition file contains a menubar name of “mbar-manager” FIG. 12 Line 17, a lookup match is obtained in the menubar name table FIG. 13 Line 5, and the corresponding menubar definition file is shown in FIG. 13 Lines 16-23.

Next, Module Load Menu Definitions 154 is called to obtain menu definition information from a Role Data Storage Means 121. Module Load Menu Definitions 154 obtains one or more menu names from a menubar definition file FIG. 13 Lines 18-23, and looks up the obtained menu names in a menu name table FIG. 14 Lines 1-11 to obtain the names of menu definition files such as those shown in FIG. 14 Lines 12-20, 21-27.

For example, if a menubar definition file contains a menu name of “menu-file” FIG. 13 Line 18 Column 4, a lookup match is obtained in the menu name table FIG. 14 Line 7, and the corresponding menu definition file is shown in FIG. 14 Lines 12-20.

Next, Module Load Toolbar Definitions 155 is called to obtain toolbar definition information from a Role Data Storage Means 121. Module Load Toolbar Definitions 155 obtains one or more toolbar names from a layout definition file FIG. 12 Lines 18-20, and looks up the toolbar names in a toolbar name table FIG. 15 Lines 1-6 to obtain the names of toolbar definition files such as shown in FIG. 15 Lines 7-27

For example, if a layout definition file contains a toolbar name of “tbar-office” FIG. 12 Line 18, a lookup match is obtained in the toolbar name table FIG. 15 Line 6, and the corresponding toolbar definition file is shown in FIG. 15 Lines 7-27.

Next, Module Load Button Definitions 156 is called to obtain button definition information from a Role Data Storage Means 121. Module Load Button Definitions 156 obtains button names from a toolbar definition file FIG. 15 Lines 7-27, and looks up the button names in a button name table FIG. 16 Lines 1-9 to obtain the names of corresponding button definition files such as shown in FIG. 16 Lines 10-18.

For example, if a toolbar definition file contains a button name of “button-file-open” FIG. 15 Line 16, a lookup match is obtained in the button name table FIG. 16 Line 5, and the corresponding button definition file “buttons-default.def” is shown in FIG. 16 Lines 10-18.

Button definition files contain various button attributes, including icon names for use in displaying buttons on toolbars. For example, the button definition file for “button-file-open” FIG. 16 Lines 1317 specifies an icon named “icon-file-open” on FIG. 16 Line 15. A lookup match for “icon-file-open” is obtained in the icon name table on FIG. 17 Line 6. The corresponding icon bitmap is named “icon-file-open.bmp.”

Both menus and buttons are associated with named GUI actions that carry out computations associated with menu choices or toolbar buttons. For example, a menu definition file associates menu choices with action names, as shown in FIG. 14 Line 17, where the action name is “a-coll-file-open” in Column 4. Similarly, a button definition file associates a button with an action name, as shown in FIG. 16 Line 16, where the action name is “a-coll-file-open” in Column 2.

When menu choices are selected, or when toolbar buttons are selected, the corresponding action name is used as a lookup key in an action name table FIG. 18 Line 7 to obtain an action definition file for execution.

Action definition files are beyond the scope of this document, because action definition files are not considered part of GUI roles. GUI roles end with action names, which are associated with the menus and toolbars that comprise GUI roles. For further information on how actions are implemented, see the related patent application “Collection Extensible Function GUI” listed at the beginning of this document.

This concludes the description of how roles are defined and loaded into a Collection Role Changing GUI. Discussion continues by describing how roles are changed, once new role data has been obtained.

Module Perform Role Change

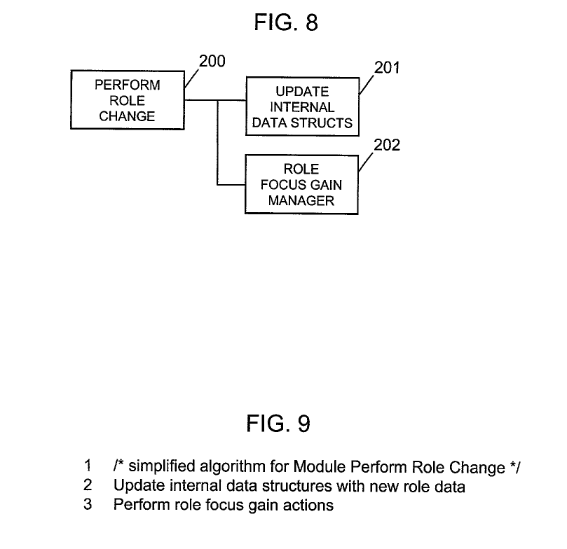

FIG. 8 shows a simplified architecture for a Module Perform Role Change 200.

Module Perform Role Change 200 oversees the performance of a role change. In particular, it oversees the updating of internal data structures, and performance of role focus gain actions.

Module Update Internal Data Structures 201 updates internal data structures as required to effect a role change. Particular data structures are not described here because they are very dependent upon particular implementations of the principles described here. Further, updating particular data structures is considered to be routine programming that is well known to the art.

Module Role Focus Gain Manager 202 performs focus gain actions in response to the gain of focus on the new role that is specified by an incoming role change request. Focus gain actions are not special; they are normal GUI actions that are listed in an action name table FIG. 18, and that are executed in the usual manner for all GUI actions. Module Role Focus Gain Manager 202 also performs focus variable and focus variable group operations required by role changes.

Operation

FIG. 9 shows a simplified algorithm for a Module Perform Role Change 200. Module Perform Role Change 200 calls various subordinate modules 201-202 to perform the work required.

First, Module Update Internal Data Structures 201 is called to perform required data structure manipulations. As stated previously, such manipulations are particular to the implementation, and are routine in nature. For example, one possible manipulation would be to create a new data structure from various name tables and definition files to contain enough information to perform a redisplay operation on a visible GUI window.

Next, Module Role Focus Gain Manager 202 is called to perform initialization or logging actions required as focus is gained by a new role.

Finally, Module Perform Role Change 200 organizes return results, and passes them back to its caller Module Role Change Manager 131 for further use in performing the requested role change operation.

Module Redisplay GUI Role

Module Redisplay GUI Role 250 completes the role change response by displaying the new GUI role on a computer display screen.

The various methods of drawing and updating GUI windows on computer screens are ubiquitous within the industry; they have been in general use for over two decades; they are described in many programming books, online articles, and are taught in various educational courses.

Therefore the specific functions performed by Module Redisplay GUI Role 250 are not described here; such functions are the usual GUI window programming functions that are well known to the art, as evidenced by the hundreds of thousands (if not millions) of different GUI windows that have been in daily use on modern computers for at least two decades.

This concludes the description of the main embodiment of a Collection Role Changing GUI. Discussion continues with various special topics.

Initial GUI Role

FIG. 10 shows an initial GUI configuration file that specifies an initial GUI role that should be used at GUI invocation time.

In operation, the GUI would look up the name of the “gui-initial-role-name” configuration parameter in FIG. 10 Line 4 Column 1 of the name table, and would find the name of the initial role in Column 2 “role-manager.”

Next, the GUI would pass the name of the initial role to Module Role Change Manager 131, which would change to the named role as described previously.

Focus Variables

Roles can set focus variable groups FIG. 11 Line 8 and individual focus variables FIG. 11 Line 9.

The main purpose of focus variables is to be used as parameters in executable action command templates. Focus variables and executable action templates are beyond the scope of this document, and have only been shown here to demonstrate their association with role definitions. For more detailed information on focus variables and executable action implementations, see the related patent application “Collection Extensible Action GUI” listed at the beginning of this document.

A secondary—but still important—use of focus variables is to provide a “context” value for use in a Collection Knowledge System or other context-sensitive knowledge providing means. A description of context-sensitive knowledge providing means is beyond the scope of this document. However, for more detailed information on one such system, see the related patent application “Collection Knowledge System” listed at the beginning of this document.

Further Advantages

As can be seen from the foregoing discussion, a Collection Role Changing GUI can change functional roles to meet the functional needs of particular user work roles. Thus a Collection Role Changing GUI provides a practical and useful means for optimizing the match between provided GUI functionality and current user functionality requirements, thereby improving user productivity in ways that were not previously possible.

### CONCLUSION

The present Collection Role Changing GUI invention provides practical solutions to six important problems faced by builders of adaptive graphical user interfaces. The problems are: (1) the overall Role Changing GUI Problem, (2) the Role Focus Gain Problem, (3) the Role Focus Variable Problem, (4) the Customized Role Problem, (5) the Sharable Role Problem, and (6) the Scalable Role Storage Problem.

The present Collection Role Changing GUI invention provides human users with a practical means for precisely adapting a GUI interface to the specific work situation at hand, using role definition means and role changing means that were not previously available.

Ramifications

Although the foregoing descriptions are specific, they should be considered as example embodiments of the invention, and not as limitations. Those skilled in the art will understand that many other possible ramifications can be imagined without departing from the spirit and scope of the present invention.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be could be spread across a different set of coherent data structures, or could be split into a plurality of smaller data structures for implementation convenience, without loss of purpose or functionality.

As a second example, particular software architectures have been presented here to more strongly associate primary algorithmic actions with primary modules in the software architectures. However, because software is so flexible, many different associations of algorithmic functionality and module architecture are also possible, without loss of purpose or technical capability. At the under-modularized extreme, all algorithmic functionality could be contained in one software module. At the over-modularized extreme, each tiny algorithmic action could be contained in a separate software module.

As a third example, particular simplified algorithms have been presented here to generally describe the primary algorithmic actions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented above comprise one such conceptual implementation, which was chosen to emphasize conceptual clarity.

From the above, it can be seen that there are many possible equivalent implementations of almost any software architecture or algorithm, regardless of most implementation differences that might exist. Thus when considering algorithmic and functional equivalence, the essential inputs, outputs, associations, and applications of information that truly characterize an algorithm should be considered. These characteristics are much more fundamental to a software invention than are flexible architectures, simplified algorithms, or particular organizations of data structures.

Practical Applications

A Collection Role Changing GUI can be used in various practical applications.

One possible application is to improve the productivity of human knowledge workers, by providing them with a practical means for configuring the functionality offered by GUI interfaces (GUI roles) to precisely match user work requirements (user work roles).

Another application is to improve the usability of modern GUI interfaces by reducing the number of GUI controls to an optimal set of GUI controls that is well-adapted to particular work situations.

Another application is to centralize the administration of GUI role knowledge within a community of users. One central store of customized role definitions can be accessed by many users through the use of Role Changing GUIs. This strategy shifts the burden of understanding and maintaining role definition knowledge from the many to the few. A Collection Knowledge System is particularly well suited for this purpose.

Other Sources of Role Change Requests

The foregoing disclosure described role change requests as being initiated by humans using GUI controls such as menus or toolbar buttons. However, other request sources and restrictions are also possible.

Role change requests can be generated by other programs and sent to a Collection Role Changing GUI. For example, a program that completes a computation could send a role change request to a Role Changing GUI, indicating completion of one work phase, and preparing the GUI for use in another work phase. In response, a Role Changing GUI would provide users with a set of menus and toolbars relevant to the next work phase.

Role change requests can also be restricted to disallow role requests of one or more types. This would simplify the role changing process by reducing the number of possible GUI roles to choose from, at the cost of reduced functionality.

Other Adaptive Knowledge Stores

The foregoing discussion identified a Role Data Storage Means 121 as a preferred means for storing role definition information used by an Role Changing GUI. Several specific means are possible.

For example, a relational database might be used to advantage, especially where large numbers of roles are involved. As another example, a network role data server could provide role information to client Role Changing GUIs by using a client-server protocol means. As a third example, role information might be stored and provided to GUIs by using an XML markup language representation, or by using a web server protocol such as HTTP.

Another important implementation of a Role Data Storage Means 121 is a Collection Knowledge System, which contains internal knowledge search rules and client/server mechanisms useful for customization, sharing, and scalability. For more detailed information on Collection Knowledge Systems, see the related patent application “Collection Knowledge System” listed at the beginning of this document.

As can be seen by one of ordinary skill in the art, many other ramifications are also possible within the teachings of this invention.

Scope

The full scope of the present invention should be determined by the accompanying claims and their legal equivalents, rather than from the examples given in the specification.

I claim:

1. A Collection Role Changing GUI process for changing a graphical user interface role, comprising the following steps:
(a) receiving a role change request, and
(b) performing a role change response to said role change request,
thereby providing a solution to the Collection Role Changing GUI Problem, and
thereby providing human users with a practical means for changing the functionality of graphical user interfaces in a way that was not previously possible.

2. The process of claim 1, wherein
(a) said step of receiving a role change request receives a role change request from a source selected from the group consisting of human operators and external programs and a GUI program that is executing said step of receiving a role change request,
thereby helping to solve the Collection Role Changing GUI Problem, and
thereby providing GUI interfaces with a practical means for responding to role change requests that originate from both inside and outside the GUI program.

3. The process of claim 1, wherein
(a) said step of performing a role change response obtains a role identifier from said role change request,
thereby helping to solve the Collection Role Changing GUI Problem, and
thereby providing a practical means for clearly identifying a particular role to be installed as part of said role change response.

4. The process of claim 1, wherein
(a) said step of performing a role change response uses a role identifier, and role data read from a role data storage means, to perform a name matching operation to identify a role definition to be installed,
thereby helping to solve the Collection Role Changing GUI Problem, and the Customized Role Problem, and the Sharable Role Problem, and the Scalable Role Storage Problem,
and thereby providing a practical means for identifying a particular role definition to be installed as part of said role change response.

5. The process of claim 1, wherein
(a) said step of performing a role change response uses role definition data read from a role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining a role definition to be installed as part of said role change response.

6. The process of claim 1, wherein
(a) said step of performing a role change response uses role definition data read from a context-sensitive role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining in a context-sensitive way a role definition to be installed as part of said role change response.

7. The process of claim 1, wherein
(a) said step of performing a role change response uses role data read from a role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining role data to use during the performance of said role change response.

8. The process of claim 1, wherein
(a) said step of performing a role change response uses role data read from a context-sensitive role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining in a context-sensitive way role data to use during the performance of said role change response.

9. The process of claim 1, wherein
(a) said step of performing a role change response uses zero or more focus variables to install a role,
thereby solving the Role Focus Variable Problem,
and thereby providing a practical means for instantiating role-specific focus variables and values as part of said role change response.

10. The process of claim 1, wherein
(a) said step of performing a role change response uses zero or more focus variable groups to install a role,
thereby solving the Role Focus Variable Problem,
and thereby providing a practical means for instantiating role-specific focus variable groups and values as part of said role change response.

11. The process of claim 1, wherein
(a) said step of performing a role change response executes one or more GUI actions selected from the group consisting of focus-loss actions and focus-gain actions,
thereby solving the Role Focus Gain Problem,
and thereby providing a practical means for executing useful focus-loss and focus-gain actions as part of said role change response.

12. The process of claim 1, wherein
(a) said step of performing a role change response uses role data selected from the group consisting of role definitions and menubar definitions and menu definitions and menu choice definitions and tool bar definitions and button definitions and focus variables and focus variable groups to update one or more internal GUI data structures while performing said role change response,
thereby helping to solve the Collection Role Changing GUI Problem,
and thereby providing a practical means for using customized and sharable role data to carry out said role change response.

13. The process of claim 1, wherein
(a) said step of performing a role change response modifies one or more visible GUI display elements selected from the group consisting of menubars and menus and menu choices and toolbars and buttons,
thereby helping to solve the Collection Role Changing GUI Problem,
and thereby providing a practical means for displaying role change results as part of said role change response.

14. The process of claim 1, wherein
(a) said step of performing a role change response communicates role change results to one or more destinations selected from the group consisting of computer memories and computer display screens and computer files and computer networks,
thereby helping to solve the Collection Role Changing GUI Problem,
and thereby providing a practical means for displaying and storing role change results as part of said role change response.

15. A programmable Collection Role Changing GUI device for changing a graphical user interface role, whose actions are directed by software executing a process comprising the following steps:
(a) receiving a role change request, and
(b) performing a role change response to said role change request,
thereby providing a solution to the Collection Role Changing GUI Problem, and
thereby providing human users with a practical means for changing the functionality of graphical user interfaces in a way that was not previously possible.

16. The programmable device of claim 15, wherein
(a) said step of receiving a role change request receives a role change request from a source selected from the group consisting of human operators and external programs and a GUI program that is executing said step of receiving a role change request,
thereby helping to solve the Collection Role Changing GUI Problem, and
thereby providing GUI interfaces with a practical means for responding to role change requests that originate from both inside and outside the GUI program.

17. The programmable device of claim 15, wherein
(a) said step of performing a role change response obtains a role identifier from said role change request,
thereby helping to solve the Collection Role Changing GUI Problem, and
thereby providing a practical means for clearly identifying a particular role to be installed as part of said role change response.

18. The programmable device of claim 15, wherein
(a) said step of performing a role change response uses a role identifier, and role data read from a role data storage means, to perform a name matching operation to identify a role definition to be installed,
thereby helping to solve the Collection Role Changing GUI Problem, and the Customized Role Problem, and the Sharable Role Problem, and the Scalable Role Storage Problem,
and thereby providing a practical means for identifying a particular role definition to be installed as part of said role change response.

19. The programmable device of claim 15, wherein
(a) said step of performing a role change response uses role definition data read from a role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining a role definition to be installed as part of said role change response.

20. The programmable device of claim 15, wherein
(a) said step of performing a role change response uses role definition data read from a context-sensitive role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining in a context-sensitive way a role definition to be installed as part of said role change response.

21. The programmable device of claim 15, wherein
(a) said step of performing a role change response uses role data read from a role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining role data to use during the performance of said role change response.

22. The programmable device of claim 15, wherein
(a) said step of performing a role change response uses role data read from a context-sensitive role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining in a context-sensitive way role data to use during the performance of said role change response.

23. The programmable device of claim 15, wherein
(a) said step of performing a role change response uses zero or more focus variables to install a role,
thereby solving the Role Focus Variable Problem,
and thereby providing a practical means for instantiating role-specific focus variables and values as part of said role change response.

24. The programmable device of claim 15, wherein
(a) said step of performing a role change response uses zero or more focus variable groups to install a role,
thereby solving the Role Focus Variable Problem,
and thereby providing a practical means for instantiating role-specific focus variable groups and values as part of said role change response.

25. The programmable device of claim 15, wherein
(a) said step of performing a role change response executes one or more GUI actions selected from the group consisting of focus-loss actions and focus-gain actions,
thereby solving the Role Focus Gain Problem,
and thereby providing a practical means for executing useful focus-loss and focus-gain actions as part of said role change response.

26. The programmable device of claim 15, wherein
(a) said step of performing a role change response uses role data selected from the group consisting of role definitions and menubar definitions and menu definitions and menu choice definitions and toolbar definitions and button definitions and focus variables and focus variable groups to update one or more internal GUI data structures while performing said role change response,
thereby helping to solve the Collection Role Changing GUI Problem,
and thereby providing a practical means for using customized and sharable role data to carry out said role change response.

27. The programmable device of claim 15, wherein
(a) said step of performing a role change response modifies one or more visible GUI display elements selected from the group consisting of menubars and menus and menu choices and toolbars and buttons,
thereby helping to solve the Collection Role Changing GUI Problem,
and thereby providing a practical means for displaying role change results as part of said role change response.

28. The programmable device of claim 15, wherein
(a) said step of performing a role change response communicates role change results to one or more destinations selected from the group consisting of computer memories and computer display screens and computer files and computer networks,
thereby helping to solve the Collection Role Changing GUI Problem,
and thereby providing a practical means for displaying and storing role change results as part of said role change response.

29. A computer readable memory, encoded with data representing a Collection Role Changing GUI program that can be used to direct a computer when used by the computer, comprising:
(a) means for receiving a role change request, and
(b) means for performing a role change response to said role change request,
thereby providing a solution to the Collection Role Changing GUI Problem, and
thereby providing human users with a practical means for changing the functionality of graphical user interfaces in a way that was not previously possible.

30. The computer readable memory of claim 29, wherein
(a) said means for receiving a role change request receives a role change request from a source selected from the group consisting of human operators and external programs and a GUI program that is executing said step of receiving a role change request,
thereby helping to solve the Collection Role Changing GUI Problem, and
thereby providing GUI interfaces with a practical means for responding to role change requests that originate from both inside and outside the GUI program.

31. The computer readable memory of claim 29, wherein
(a) said means for performing a role change response obtains a role identifier from said role change request,
thereby helping to solve the Collection Role Changing GUI Problem, and
thereby providing a practical means for clearly identifying a particular role to be installed as part of said role change response.

32. The computer readable memory of claim 29, wherein
(a) said means for performing a role change response uses a role identifier, and role data read from a role data storage means, to perform a name matching operation to identify a role definition to be installed,
thereby helping to solve the Collection Role Changing GUI Problem, and the Customized Role Problem, and the Sharable Role Problem, and the Scalable Role Storage Problem,
and thereby providing a practical means for identifying a particular role definition to be installed as part of said role change response.

33. The computer readable memory of claim 29, wherein
(a) said means for performing a role change response uses role definition data read from a role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining a role definition to be installed as part of said role change response.

34. The computer readable memory of claim 29, wherein
(a) said means for performing a role change response uses role definition data read from a context-sensitive role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining in a context-sensitive way a role definition to be installed as part of said role change response.

35. The computer readable memory of claim 29, wherein
(a) said means for performing a role change response uses role data read from a role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining role data to use during the performance of said role change response.

36. The computer readable memory of claim 29, wherein
(a) said means for performing a role change response uses role data read from a context-sensitive role data storage means to perform said role change response,
thereby helping to solve the Collection Role Changing GUI Problem, and the Customized Role Problem, and the Sharable Role Problem, and the Scalable Role Storage Problem,
and thereby providing a practical means for obtaining in a context-sensitive way role data to use during the performance of said role change response.

37. The computer readable memory of claim 29, wherein
(a) said means for performing a role change response uses zero or more focus variables to install a role,
thereby solving the Role Focus Variable Problem,
and thereby providing a practical means for instantiating role-specific focus variables and values as part of said role change response.

38. The computer readable memory of claim 29, wherein
(a) said means for performing a role change response uses zero or more focus variable groups to install a role,
thereby solving the Role Focus Variable Problem,
and thereby providing a practical means for instantiating role-specific focus variable groups and values as part of said role change response.

39. The computer readable memory of claim 29, wherein
(a) said means for performing a role change response executes one or more GUI actions selected from the group consisting of focus-loss actions and focus-gain actions,
thereby solving the Role Focus Gain Problem,
and thereby providing a practical means for executing useful focus-loss and focus-gain actions as part of said role change response.

40. The computer readable memory of claim 29, wherein
(a) said means for performing a role change response uses role data selected from the group consisting of role definitions and menubar definitions and menu definitions and menu choice definitions and toolbar definitions and button definitions and focus variables and focus variable groups to update one or more internal GUI data structures while performing said role change response,
thereby helping to solve the Collection Role Changing GUI Problem,
and thereby providing a practical means for using customized and sharable role data to carry out said role change response.

41. The computer readable memory of claim 29, wherein
(a) said means for performing a role change response modifies one or more visible GUI display elements selected from the group consisting of menubars and menus and menu choices and toolbars and buttons,
thereby helping to solve the Collection Role Changing GUI Problem,
and thereby providing a practical means for displaying role change results as part of said role change response.

42. The computer readable memory of claim 29, wherein
(a) said means for performing a role change response communicates role change results to one or more destinations selected from the group consisting of computer memories and computer display screens and computer files and computer networks,
thereby helping to solve the Collection Role Changing GUI Problem,
and thereby providing a practical means for displaying and storing role change results as part of said role change response.
